(19) United States
(12) Patent Application Publication
(10) Pub. No.: US 2009/0034384 A1
(43) Pub. Date: Feb. 5, 2009

(54) Detection Of Data Degeneration Within Optical Discs

(75) Inventor: Josephus Joannes Mathijs Geelen, Elsloo (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,908

(22) PCT Filed: Jun. 27, 2006
(86) PCT No.: PCT/IB2006/052121

§ 371 Date: Jul. 14, 2008

Related U.S. Application Data
(60) Provisional application No. 60/695,087, filed on Jun. 29, 2005.

(51) Int. Cl. G06F 3/12

(52) U.S. Cl. 369/53.35

(57) ABSTRACT

A system and method for detecting degeneration in an optical media by defining a set of error correction code (ECC) blocks uniformly on an optical media and reading each of the ECC blocks to determine a number of correctable errors for each of the ECC blocks once the optical media is placed into use. The result of the reading of the ECC blocks is stored on the optical media. The reading of the ECC blocks can be a repetitive reading of each of the ECC blocks with the results for each of the ECC blocks averaged. Each ECC block from the set is readout several times and for each ECC block the average number of ECC Corrections is memorized also on disc. Degeneration of the optical should be uniform over the disc. By performing the reading of the ECC blocks over a long period of time, long term degradations of the disc can be determined and an indication made that data on the disc should be copied to another storage device. The set of ECC blocks are chosen uniform over the disc surface, so that scratches, blacks spot statically can be eliminated.

The present invention relates to defect management within storage media and more particularly, to detecting defects that occur through normal degeneration of optical disc media.

Numerous standards exist for the provision of storage on optical disc. Among these are CD, CD-R, CD-R/W, DVD, DVD-R, DVD+R, DVD+RW, DVD-R/W and Blu-ray Disc (BD) formats. These various standards provide for ROM types of media, recordable types of media and recordable/erasable types of media. The optical media used within each of these standards provides for long term storage, however, the optical media will eventually begin to degenerate with age. As the optical media degenerates with age, the recording layer will also degenerate resulting in an increase in the number of errors during readout of the data that was previously written on the optical media. These errors can be either correctable errors or un-correctable errors. The correctable errors can be corrected by the system up to a certain threshold amount, which amount depends upon the standard that is employed for the specific type of optical media being used. Un-correctable errors are always unacceptable. As optical media ages, eventually, the number correctable errors will begin to exceed the maximum allowed for that particular standard. Therefore, a problem that exists within the art of optical media in determining the proper time period in which data contained on old media should be copied to a newer optical media in order to preserve the data before it becomes impossible to recover all the data.

Additionally, there remains a need within the art for a system and method that can identify normal degeneration within the disc to prevent error loss.

It is an object of the invention to address the aforementioned needs within the prior art and to provide a determination that data recorded on an optical media should be rerecorded on a new optical media in order to preserve a rewrite action, wherein, only one attempt at rewriting data is required once a write error is detected.

The foregoing objects are addressed by embodiments defining a method and system for identifying that a storage media has degenerated to a point that it is suggested that the data on that storage media by copied to a new or different storage media.

An embodiment places ECC codes in a uniform manner on the optical media. Upon insertion of a disc into a player/recorder, the ECC codes are read and a determination is made of the number of corrections that have been made for each of the ECC blocks. A record is made of the number of corrections that have been made for each of the ECC blocks by storing that number on the optical media. These corrections are generally referred to as correctable corrections in that error correction that is provided on the optical media is capable of deciphering the correct data from the corrupt data that created the error. The number of corrections that are made for each of the ECC blocks is compared with previous records representing the corrections that have been made for each of the ECC blocks. It is envisioned that as the recording layer of the optical disc becomes older, that a relatively uniform degradation of the recording layer will take place. As the optical media get older, eventually, the number of corrections required for each of the ECC blocks will increase. A threshold is determined based on either the number of correctable errors that are currently being read from the ECC blocks, the rate at which the correctable errors are increasing from previous readings of the ECC blocks, or a combination of both to establish a point at which it becomes apparent that the current storage media being used should have that data recorded thereon transferred to another storage media to prevent loss of that data. A response is made to the number of error by either proceeding to use the optical media normally if the number of ECC corrections does not exceed the predetermined threshold or providing an indication that the number of ECC corrections exceeds the predetermined threshold.

In another embodiment, the set of error correction code (ECC) blocks are placed in a uniform manner on the optical media and read each time the optical media is placed into use. The reading of each of the set of ECC blocks is performed several times and an average of the errors read out for each of the set of the ECC bloc is determined. The determined average of the various ECC blocks is compared a predetermined threshold indicative of an acceptable level of corrections. The acceptable level of corrections can be either total number of correctable errors, the rate at which the correctable errors is increasing determined from previous readings or a combination of both. The average of the correctable errors from the various ECC blocks is memorized by storing these values on the optical media. A response is made to this average number of errors for the various ECC blocks by either proceeding to use the optical media normally if the number of ECC corrections does not exceed the predetermined threshold or providing an indication that the number of ECC corrections exceeds the predetermined threshold and that the data on the current optical media should be stored be saved on a different storage device.

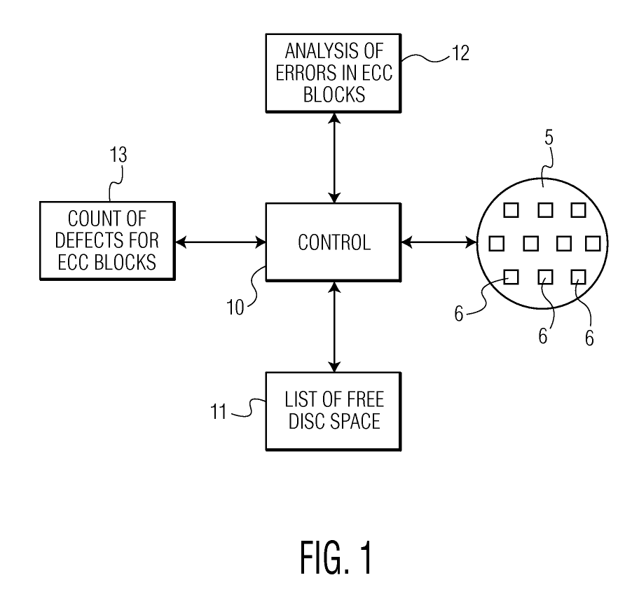

FIG. 1 is a block diagram illustrating the basic system envisioned by the invention;

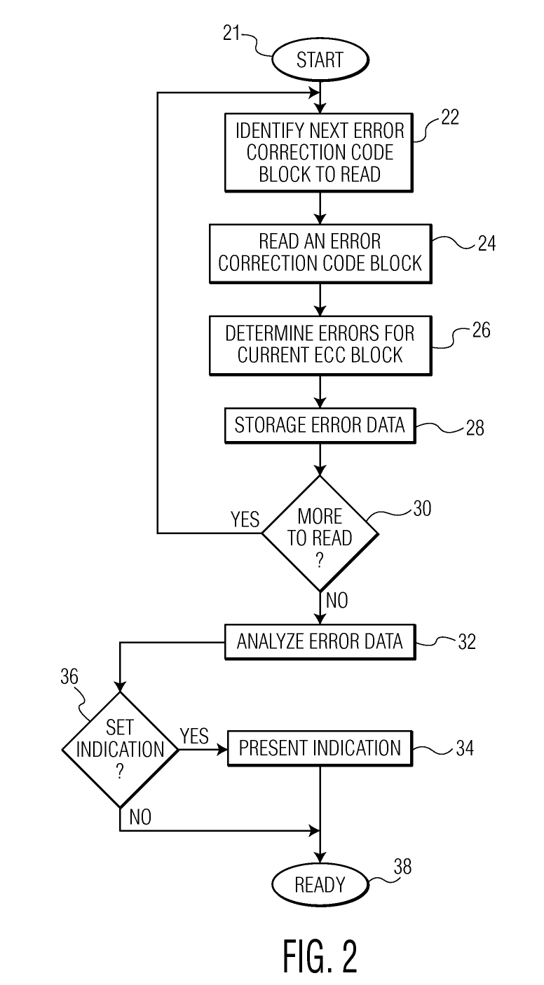

FIG. 2 is a flow chart for an embodiment of the invention.

Information layers on an optical medias, such as CD-R/W, DVD±R/W and Blu-ray, hold the recorded data tend to degenerate slowly over long periods of time (years). These optical disc media are commonly used for archiving data. As the recording layer degenerates, a level of degeneration is reached such that the data stored on that optical media needs to be copied to another storage device. The embodiments described herein detail a system and method to provide an indication at which point it is necessary to copy the data to another storage medium.

Optical media typically employ Error Detection Codes (EDC) to detect errors that occur within data stored on the optical media; these errors can be correctable or un-correctable errors. Un-correctable errors result in the data not being useable. Correctable errors can be corrected by Error Correction Codes (ECC) contained on the optical media. The ECC can correct the correctable errors only up to a certain amount, determined by the standard employed for that particular type of optical media. If the number of correctable errors is below a certain maximum amount, then data can be fully corrected. As optical media ages, the recording layers degenerate as previously discussed, resulting in increases in the number of correctable errors. During reading of an optical media, the ECC blocks yield the number of defects found and repaired which is an indication of the current readout quality of that optical media. As the information layer degenerates it results in an increase in the number of defects. By analyzing the number of defects, it is possible to detect degeneration of the recording layer and to provide a warning before the number of correctable errors becomes too large and reaches the point that they can no longer be corrected by the ECC blocks or becomes un-correctable errors.

Initially a set of ECC blocks is defined. Each ECC block from the set is readout several times and for each ECC block the average number of ECC corrections made is memorised also on disc. Performing this procedure regularly, over a long period of time can detect degradation of the disc. The set of ECC blocks should be chosen to be relatively uniform over the disc surface, so that scratches, blacks spot statically can be eliminated. Over a long period of time, medium degeneration should be uniform over the disc surface; therefore, the number of ECC corrections should increase in a relatively uniform manner across the disc surface.

Referring to FIG. 1, in accordance with an embodiment of the invention, ECC codes 6 are placed in a uniform manner on an optical media 5. Control 10 is a very high level generalization of the system mechanics, electronics and optics employed within optical disc players/readers to read from and write to optical storage devices such as optical media 5. Upon insertion of a disc into a player/recorder, control 10 begins to read the ECC codes 6 are read and a determination is made of the number of corrections that have been made for each of the ECC blocks by Count Defects for ECC Blocks 13. It will be understood by those skilled in the art that optical media 5 in FIG. 1 is not a true to scale representation and that the ECC Blocks 6 will be much smaller and much more numerous. Analysis of Errors in ECC Blocks 12 will look to the errors that are currently occurring in the reading optical media 5 and make a determination of overall quality of the optical media 5. Control records of the number of corrections that have been made for each of the ECC blocks by storing that number on the optical media. These corrections are generally referred to as correctable corrections in that error correction that is provided on the optical media is capable of deciphering the correct data from the corrupt data that created the error.

In another embodiment, the number of corrections that are made for each of the ECC blocks 6 is compared with previous records representing the corrections that have been made for each of the ECC blocks. As the recording layer of the optical media 5 becomes older, a relatively uniform degradation of the recording layer will take place. As the optical media get older, eventually, the number of corrections required for each of the ECC blocks 6 will increase. A threshold is determined by analysis of Errors in ECC Blocks 12 based on either the number of correctable errors that are currently being read from the ECC blocks, the rate at which the correctable errors are increasing from previous readings of the ECC blocks, or a combination of both to establish a point at which it becomes apparent that the current optical media 5 being used should have that data recorded thereon transferred to another storage media to prevent loss of that data. A response is made to the number of errors by either proceeding to use the optical media normally if the number of ECC corrections does not exceed the predetermined threshold or providing an indication that the number of ECC corrections exceeds the predetermined threshold.

In another embodiment, the set of error correction code (ECC) blocks 6 are placed in a uniform manner on the optical media 5 and read each time the optical media is placed into use. Each of the set of ECC blocks 6 is read several times and Count Defect for ECC Blocks 13 determines an average of the errors read out for each of the set of the ECC blocks 6 and uses that average as the count. Analysis of Errors in ECC blocks 6 takes the determined averages for the various ECC blocks 6 and compares the determined averages with a predetermined threshold indicative of an acceptable level of corrections. The acceptable level of corrections can be either the total number of correctable errors, the rate at which the correctable errors are increasing as determined from viewing previous readings or a combination of both. The average of the correctable errors from the various ECC blocks is memorized by control 10 storing these values on optical media 5. A response is made to this average number of errors for the various ECC blocks by either proceeding to use the optical media normally if the number of ECC corrections does not exceed the predetermined threshold or providing an indication that the number of ECC corrections exceeds the predetermined threshold and that the data on the current optical media should be stored be saved on a different storage device.

In another embodiment, the ‘error data’ is stored on the target disc as a file or in reserved areas outside the logical address space. Error data that is stored on the disc is encoded with the same ECC structure as used for normal data. Reserved areas on the disc could also be used; however, due to differences in the various disc standards this may be more complicated. Furthermore, not all standards provide room for such an area. It will be readily apparent that storing of ‘error data’ on the same disc is not always possible, particularly for read only media and finalized recordable media. For these media the ‘error data’ could be stored on another media with read/write capability. Alternatively, the scan algorithm can use only the maximum threshold to determine if the disc must be copied or not.

FIG. 2 is a flow diagram illustrating the basic algorithm employed by the embodiments as previously described. The above discussed embodiments can be implemented for use with CD, CD-R, CD-R/W, DVD, DVD-R, DVD+R, DVD+RW, DVD-R/W and Blu-ray (BD) types of optical media. Each of these different formats will have information organized into blocks of information that each contains a certain number of bytes of user data plus bytes of error correction data, sync marks and address information. The routine is entered at start 21 once control 10 begins reading optical media 5. As control 10 reads the data on the disc it also sequentially identifies the Next ECC Blocks 6 to Read 22. Read ECC Block 24 reads the current ECCC block 6 and Determine Errors for Current ECC Block 26 will determine the number of errors that have occurred for that ECC Block 6. The number of errors for the ECC Block 6 can be determined by a single read or an average number or errors determined by multiple reads. Store Error Data 28 will memorialize that the error data for that ECC Block 6 by storing the error data on the disc so that it is associated with that ECC Block 6. The foregoing steps will be repeatedly cycled through until the result of More to Read 30 is negative at which point Analyze Error Data 32 will determine if the errors on the optical media 5 indicate severe degradation of the recording layer to the optical media 5. Set indication 36 will set a flag if the result of Analyze Error Data 32 indicates that Present Indication 34 should be performed. Present Indication 34 will alert the user that the data on the optical media 5 should be copied to another storage device to prevent the loss of the data, followed by exiting the routine at ready 38. If the result of Analyze Error Data does not indicate severe degradation of the recording layer, then Set Indication will not set a flag and the routine will exit at ready 38.

The foregoing description details the embodiments most preferred by the inventor. Variations of these embodiments will be readily apparent to those skilled in the art, therefore the scope of the invention should be measured by the appended claims.

1. A method for determining errors on an optical media comprising:
defining a set of error correction code (ECC) blocks in a uniform manner on the optical media;
reading each of the set of ECC blocks;
determining a number of ECC corrections for the set of ECC blocks;
comparing the number of ECC corrections with a predetermined threshold indicative of an acceptable level of corrections; and
responding to the step of comparing by either proceeding to use the optical media normally if the number of ECC corrections does not exceed the predetermined threshold or providing an indication that the number of ECC corrections exceeds the predetermined threshold.

2. The method of claim 1 wherein the step of reading further comprises reading each of the set of ECC blocks several times.

3. The method of claim 2, wherein the step of determining further comprises determining an average number of ECC corrections for each of the set of ECC blocks and storing the average number of ECC corrections on the optical media.

4. The method of claim 3, wherein the step of comparing further comprises comparing the average number of ECC corrections with a previously stored average number of ECC corrections for each of the set of ECC blocks.

5. The method of claim 4 wherein the step of responding further comprises responding to the comparing step by either proceeding to use the optical media normally if the number of ECC corrections does not exceed the predetermined threshold or providing an indication that the number of ECC corrections exceeds the predetermined threshold.

6. The method of claim 1 further comprising the step of storing the number of ECC corrections.

7. The method of claim 6 wherein the step of storing the number of ECC corrections further comprises storing the number of ECC corrections on the optical media as a file.

8. The method of claim 6 wherein the step of storing the number of ECC corrections further comprises storing the number of ECC corrections on the optical media in reserved areas outside the logical address space.

9. The method of claim 6 wherein the step of storing the number of ECC corrections further comprises storing the number of ECC corrections on the optical media encoded with the same ECC structure as the set of ECC blocks.

10. The method of claim 1 wherein the predetermined threshold is a maximum threshold and the step of responding further comprises alerting that the optical media must be copied if the maximum threshold is reached.

11. A system for determining errors on an optical media comprising:
an optical system capable of reading a set of error correction code (ECC) blocks that are contained on the optical media in a uniform manner;
a processing device programmed to determine a number of ECC corrections for the set of ECC blocks;
a comparison routine that compares the number of ECC corrections with a predetermined threshold indicative of an acceptable level of corrections; and
a response routine that responds to the comparison routine by either proceeding to use the optical media normally if the number of ECC corrections does not exceed the predetermined threshold or providing an indication that the number of ECC corrections exceeds the predetermined threshold.

12. The system of claim 11 wherein the optical system is further capable of reading further comprises reading each of the set of ECC blocks several times.

13. The system of claim 12, wherein the processing device further determines an average number of ECC corrections for each of the set of ECC blocks and storing the average number of ECC corrections on the optical media.

14. The system of claim 13, wherein the comparison routine further comprises an averaging routine that averages the number of ECC corrections with a previously stored average number of ECC corrections for each of the set of ECC blocks.

15. The system of claim 14 wherein the response routine further responds to the comparison routine step by either proceeding to use the optical media normally if the number of ECC corrections does not exceed the predetermined threshold or providing an indication that the number of ECC corrections exceeds the predetermined threshold.

16. The system method of claim 11 wherein the optical system is further capable of storing the number of ECC corrections.

17. The system of claim 16 wherein the optical system stores the number of ECC corrections on the optical media as a file.

18. The system of claim 16 wherein the optical system stores the number of ECC corrections on the optical media in reserved areas outside the logical address space.

19. The system of claim 16 wherein the optical system stores the number of ECC corrections on the optical media encoded with the same ECC structure as the set of ECC blocks.

20. The system of claim 11 wherein the predetermined threshold is a maximum threshold and the response routine further comprises an alert routine that provides an alert that the optical media must be copied if the maximum threshold is reached.
